(19) United States
(12) Patent Application Publication
(10) Pub. No.: US 2003/0191577 A1
(43) Pub. Date: Oct. 9, 2003

(54) Road safety street furniture

(76) Inventor: Jean-Claude Decaux, Neuilly (FR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/358,549

(22) Filed: Feb. 5, 2003

(30) Foreign Application Priority Data
Apr. 5, 2002 (FR) 0204274
Apr. 5, 2002 (FR) 0204275
Apr. 15, 2002 (FR) 0204694
Sep. 2, 2002 (FR) 0210852

(51) Int. Cl. G06F 19/00

(52) U.S. Cl. 701/117

(57) ABSTRACT

Road safety street furniture intended to be installed alongside a highway for vehicles so as to ensure the safety of persons located in a protection zone, the street furniture comprising means of detection of an unforeseeable risk liable to affect a person located in said protection zone, and signaling means linked to the means of detection and intended to draw the attention of drivers of vehicles and of persons to the detected risk.

The present intention relates to road safety street furniture, intended to he installed alongside a highway for vehicles so as to ensure the safety of the persons located in a protection zone determined with respect to the site of this street furniture.

It is known practice to construct road safety devices having continuous signaling, with the aim of raising the awareness of people, be they pedestrians or drivers of motor vehicles, to the dangers of a particular zone.

In particular, signaling panels comprising luminous display means and optionally audible warning means are known.

Also known are devices set up alongside roads and comprising means for detecting the speed of the vehicles traveling on these roads, and means for displaying signals or messages when the detected speeds of the vehicles are greater than an imposed limit speed.

The known devices have the drawback that the people for which the signalings and the messages are intended very quickly become accustomed to these displays when they frequently go past the same devices and no longer pay attention thereto.

Furthermore, these devices are generally totally ignored by people (pedestrians or drivers) when they continually signal a potential danger which materializes only irregularly or infrequently.

Also known are means of signaling for the attention of pedestrians, which are small luminous panels associated with the traffic lights and which represent two silhouettes, one stationary and the other walking, illuminated alternately depending on whether the light is green or red. In certain cases, the traffic lights are controlled by a detector of presence of a vehicle in the immediate vicinity of a traffic light.

These means are not however capable of signaling to pedestrians a particular risk or event which it not predetermined, they are installed only at places equipped with traffic lights and are controlled only by the changing of state of these lights.

Hence, no device is known in the art which is capable of signaling, both to pedestrians located in a specified zone, and also to the drivers of vehicles heading toward this zone, the existence of a particular risk caused by the behavior of the pedestrians and/or by the behavior of the drivers of the vehicles.

The aim of the present invention is in particular to address this requirement, while avoiding the aforesaid drawbacks of the known devices.

Accordingly, it proposes road safety street furniture intended to be installed alongside a highway for vehicles so as to ensure the safety of persons located in a protection zone determined with respect to said street furniture, characterized in that it comprises:

means of detection of a risk liable to affect a person located in said protection zone,

and signaling means linked to the means of detection and intended to draw the attention of any person located in the protection zone to the detected risk.

In a preferred embodiment of the invention, the detection means comprise means of detection of the speed of at least one vehicle travelling toward or in the protection zone.

Advantageously, these detection means also comprise means of detection of environmental parameters in the protection zone or in the vicinity of the latter, these environmental parameters comprising in particular the weather conditions, visibility, the state of the road or of the carriageway, and the detection means comprise means of detection of a particular state or of an event such as the arrival or the departure of a train, of a bus or of a streetcar, the closure or the opening of a barrier, the switching of a traffic light to red or to green, etc.

Thus, upon the occurrence of a fortuitous, unexpected or non-predetermined event pertaining to the protection zone or its vicinity, and which is liable to be a risk factor in respect of the persons located in the protection zone, the aforesaid detection means generate a signal corresponding to the event or to the risk detected and transmit it to the signaling means which themselves generate signals warning the person or persons located in the protection zone.

According to another characteristic of the invention, the signaling means comprise means of visual and/or audible signaling and means for displaying messages.

In accordance with another aspect of the invention, this road safety street furniture also comprises second signaling means, linked to the aforesaid detection means and intended to inform the drivers of the vehicles traveling toward or in the protection zone.

Advantageously, this street furniture also comprises means for detecting the presence of at least one person in the protection zone, these detection means being linked, like the aforesaid detection means, to the second signaling means.

The street furniture furthermore comprises means for generating messages linked to the detection means and to the aforesaid signaling means and generating messages which are variable as a function of the output signals from the detection means.

The messages produced comprise first messages intended for the persons located in the protection zone and second messages intended for the drivers of the vehicles, these first and second messages possibly being simultaneous and mutually correlated, or else independent of one another.

In a particular embodiment of the invention, the means for generating messages comprise a memory containing prerecorded messages and means for selecting messages from this memory as a function of the output signals from the detection means.

In particular, the messages may be selected as a function of at least two different parameters detected by the detection means, one of these parameters consisting, preferably, of the speed of a vehicle traveling toward or in the protection zone.

Advantageously, the memory contains different messages corresponding to identical situations, and the selection of a message corresponding to a given situation is performed in a random manner from among several messages corresponding to this situation.

In preferred embodiments of the invention, the aforesaid detection means comprise vehicle speed detectors of the radar or laser type or of the type having magnetic loops built into the carriageway, radar detectors, laser detectors or infrared detectors for detecting the presence of persons in the protection zone, and/or at least one video camera associated with image processing means, and the signaling means comprise panels for alphanumeric display and/or for displaying pictograms and/or video screens.

In a more sophisticated embodiment of the invention, the signaling means also comprise emitters of signals intended to be picked up by receivers mounted on board the vehicle.

Finally, according to another embodiment of the invention, this road safety street furniture also comprise means for recording and optionally for transmitting data relating to a detected event, such as, for example, the excessive speed of a vehicle traveling toward or in the protection zone.

In this case, the data recorded and optionally transmitted may comprise the detected speed of the vehicle and the identification of the vehicle.

It is also possible for data processing means, in particular statistical processing means, for the transmission of global information such as the traffic density at certain times, to be built into the street furniture.

The invention will be better understood and other characteristics, details and advantages thereof will become more clearly apparent on reading the description which follows, given by way of example with reference to the appended drawings, in which:

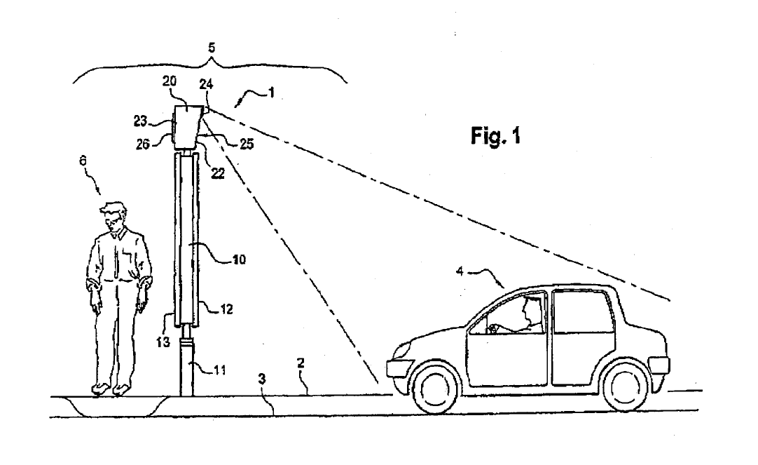

FIG. 1 diagrammatically represents a first embodiment of the road safety street furniture according to the invention;

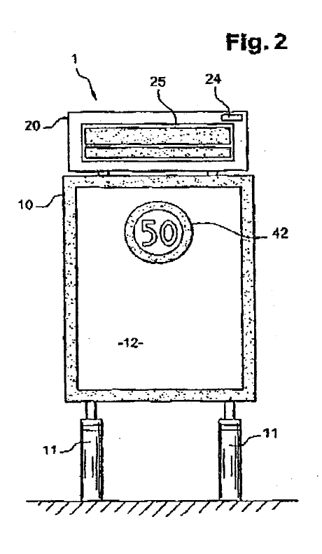

FIG. 2 is a front view of this street furniture;

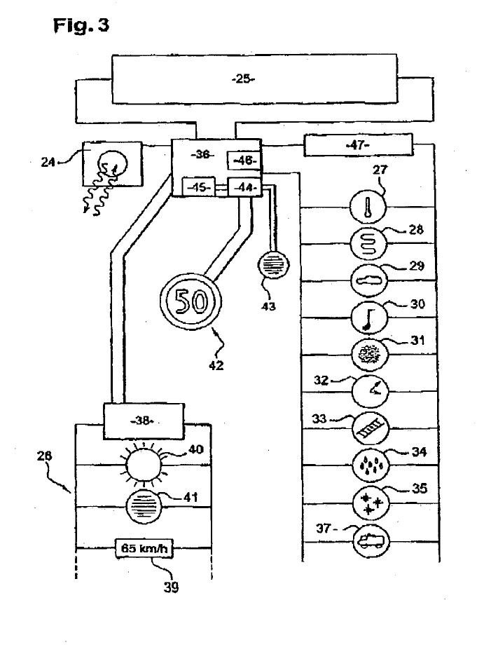

FIG. 3 represents in the form of block diagrams the essential components of the street furniture according to the invention;

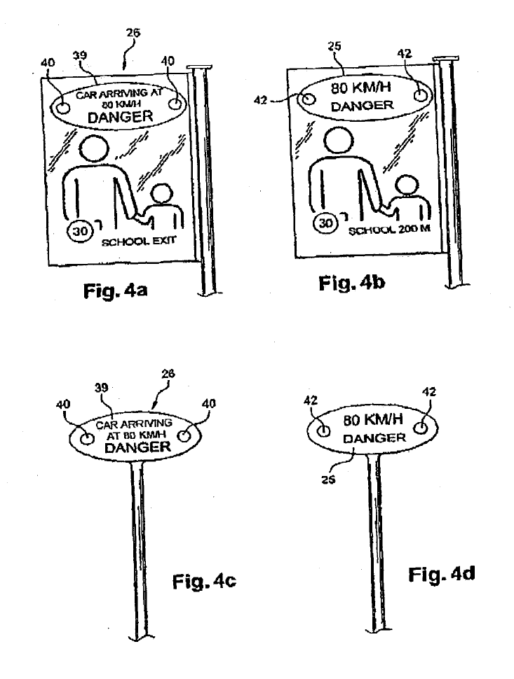

FIGS. 4a to 4d represent examples of signaling of a risk by means of the street furniture according to the invention as a function of the detected speed;

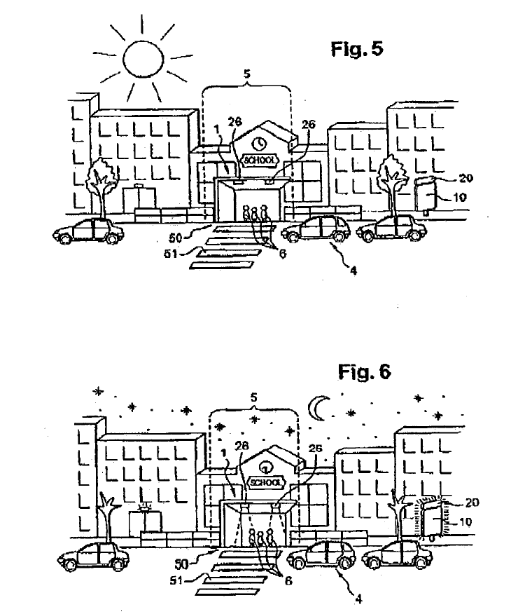

FIGS. 5 and 6 diagrammatically illustrate the manner of operation of a variant embodiment of the street furniture according to the invention;

FIG. 7 is a diagrammatic view from above representing another embodiment of the street furniture according to the invention;

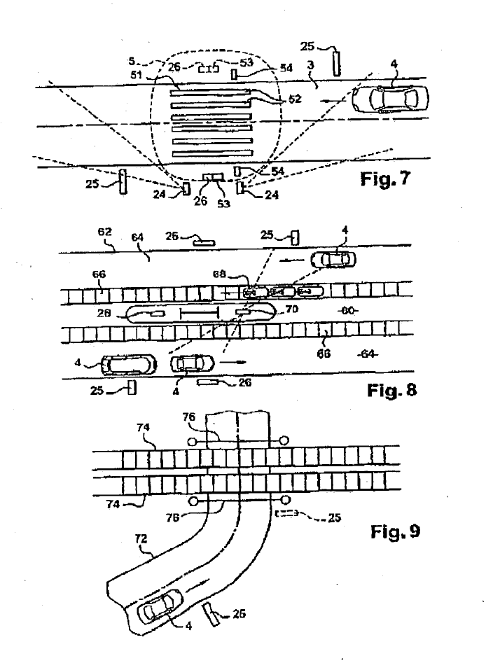

FIG. 8 is a diagrammatic view from above of yet another embodiment of the street furniture according to the invention;

FIG. 9 is a diagrammatic view from above representing street furniture according to the invention, installed in the vicinity of the intersection of a road and a railroad track.

Reference is first of all made to FIGS. 1 to 4 relating to a first embodiment of the invention, in which the road safety street furniture 1 is installed on a sidewalk 2 bordering a road 3 on which a motor vehicle 4 is traveling, heading toward a protection zone 5 situated in the vicinity of the street furniture 1 according to the invention, and in which there is a person 6, who is getting ready for example to cross the road 3, in front of the vehicle 4.

The street furniture according to the invention comprises in this example a panel of a known type, comprising a box 10 resting on one or more feet 11 and making it possible to post up signs having a relatively sizable format, for example of the order of 1.7 m×1.1 m

The front face 12 of the box 10 is oriented toward the vehicle 4, for example perpendicularly to the road and, as represented in FIG. 2, can comprise means of displaying a message or a signal for the attention of the driver of the vehicle 4.

The rear face 13 of the box 10 can for its part serve only for the posting up of a sign.

The box 10 is surmounted by an upper box 20 whose front face 22 and rear face 23 are oriented perpendicularly to the road 7, this upper box 20 comprising a certain number of detection and display means, in particular means 24 for detecting the speed of the vehicle 4 heading toward the protection zone 5, means 25 for displaying signals and messages for the attention of the driver of the vehicle 4 and means 26 for signaling, for the attention of the person 6 located in the protection zone 5, the risk constituted by the arrival of the vehicle 4.

The box 20 can be mounted fixedly or orientably on the box 10. As a variant, the detection means and the display and signaling means can be built into the box 10 or installed in the vicinity of the latter.

In a more detailed manner, and as represented diagrammatically in FIG. 3, the detection means comprise, in addition to the speed detector 24, at least some of the following means:

a temperature sensor 27, for signaling a low temperature liable to give rise to black ice or a high temperature liable to modify the general concentration of the persons present;

a brightness sensor 28, making it possible to signal semi-darkness or surrounding darkness or on the contrary a risk of dazzling;

a sensor 29 making it possible to signal the presence of water on the carriageway, liable to modify the running and braking conditions of the vehicles,

a noise sensor 30, for signaling unusual conditions of ambient noise which would be liable to modify the general concentration of the persons present, such as for example the use of a siren by a priority vehicle or the background noise produced by a packed crowd,

a fog sensor 31, for signaling a reduction in visibility,

a clock 32, making it possible to ascertain a usual congestion of the road, at peak times,

a pass-by sensor 33, making it possible to ascertain the density of the road traffic or the presence or the passing by of a vehicle of a special type, such as a bus or a streetcar for example on an adjoining roadway,

a rain sensor 34, making it possible to signal a reduction in visibility and a modification of the running and braking conditions of the vehicles,

a snow sensor 35, making it possible to ascertain a reduction in visibility caused by the falling of snow and the presence of snow on the carriageway.

Other sensors of different types may of course also be used, in particular a means 37 for receiving messages which are emitted in certain countries by priority vehicles so as to forewarn other vehicles that they are passing or approaching.

These various sensors are built into the upper box 20 of the street furniture according to the invention or installed at different places, and are then linked to the circuits of the box 20 by wire links or wireless links, for example by radio waves.

The various detection means are linked to message generation means 36, which are themselves linked at the output to the aforesaid signaling and display means 25, 26.

The means 25 installed on the front face 22 of the upper box 20 are display screens of any appropriate type for example of the plasma type, diode type or liquid crystal type, which preferably comprise lines of writing each comprising several modules of several columns, for example four modules of 48 columns, each column possibly comprising 25 rectangular pixels 4.5 millimeters high with a horizontal pitch of 5.5 millimeters.

Means are associated with this display screen for modifying the font of the characters displayed, modifying the size of these characters, boosting their luminous intensity, producing a flashing of the display, etc.

The means 26 of signaling for the attention of persons 6 located in the protection zone 5 comprise for example a circuit 38 powering a screen 39 for displaying the detected speed of the arriving vehicles 4, means 40 of visual signaling such as for example a flashing light, a flash lamp, a strobe light, etc., and an audible or vocal emitter 41 such as a siren, a horn, or a loudspeaker, for emitting sound waves whose intensity, frequency and duration may be modulated.

Moreover, additional signaling means may be provided for the attention of the drivers of the vehicles 4, these additional means comprising a display screen 42 of the plasma, diode or liquid crystal type for example, placed on the front face 12 of the box 10 for the reproduction of a signal of a speed limit panel, and an audible emitter 43 such as for example a siren, a horn, a whistle, or a loudspeaker. These means 42 and 43 are powered by an appropriate circuit 44, forming part of the message generation means 36.

These means 36 can also comprise an emitter 45 generating a particular signal intended to be picked up by a receiver mounted on board the vehicle 4, this signal being for example of the W-LAN (Wireless Local Access Network) type or the like.

The messages generated by the means 36 and intended, on the one hand for the means 25 and 42 of display for the attention of the drivers of vehicles, and on the other hand for the means 26 of display or of signaling for the attention of the persons 6 located in the protection zone 5, are variable and differentiated, these messages being variable so as to be matched to the risks or to the events detected by the aforesaid detection means, and being differentiated as a function of their intended recipients who are the drivers of vehicles or the persons 6 located in the protection zone on the sidewalk or on a protected right of way crossing the road.

In a particular embodiment of the invention, the means 36 for generating messages comprise a memory 46 in which are recorded groups of preset messages, each group of messages corresponding to an event or to a given situation, and means 47 of random selection of messages which are linked, on the one hand to the outputs of the aforesaid detection means and on the other hand to the means 3S for generating messages and which randomly select messages from the groups themselves chosen as a function of one or preferably several different parameters detected by the aforesaid means.

These messages are displayed on panels of the type of those represented diagrammatically in FIGS. 4a to 4d.

FIGS. 4a and 4b represent two panels, one 26 of which is installed at the exit of a school for signaling a risk for the attention of the children and of the adults leaving the school, and the other of which is installed some distance from the school for signaling for the attention of the vehicle drivers.

The panel 26 of FIG. 4a comprises a screen 39 for displaying an alphanumeric message, two flashing lamps 40, optionally an audible emitter, and a sign or the like representing a standard speed limit panel and a pictogram of the type of those signaling school exits to motorists.

The message displayed on the screen 39 indicates in particular an arriving vehicle's speed detected by the aforesaid means 24. In the case represented where the speed is excessive, the lamps 40 flash and an audible signal is emitted.

The panel of FIG. 4b is of the same type, and comprises a screen 25 for displaying an alphanumeric message, flashing lamps 42, and a sign or the like indicating the distance from the school exit, a speed limit and a pictogram similar to that of the panel of FIG. 4a.

The messages displayed on the screens 39, 25 of the two panels are simultaneous, correlated, and differentiated as a function of their intended purpose.

In the variant embodiment of FIGS. 4c and 4d, the panels for signaling for the attention of the pedestrians and of the drivers do not comprise any signs, but alphanumeric display screens 39, 25 and flashing lamps 40, 42 with optionally an audible emitter for the panel 26 of FIG. 4c and can be installed eat the exits of schools, hospitals, factories, public establishments, in zones with poor visibility, at the entrances to built-up areas, etc.

The variable messages generated for the attention of the vehicle drivers may be of several different types, as indicated hereinbelow.

When the detected vehicles approach the protection zone at a speed less than or equal to 30 km/hour for example, the lamps 42 are unlit and the message displayed on the screen 25 is chosen randomly from among several such as:

moderate speed=well-regarded driver

moderate speed=considerate driver

speed complied with=thank you

If the detected speed of a vehicle approaching the protection zone lies between 30 and 50 km/hour for example, the lamps 42 light up and the messages displayed on the screen 25 are for example chosen from among:

faster is too fast

ease off, reduce speed

excessive speed, slow down

When the detected speed of the arriving vehicle is greater than 50 km/h. the lamps 42 light up and flash, and the messages displayed on the screen 25 are chosen from among:

take control, reduce speed!

speed+children=danger!

speed is not vital!

As indicated above, the means for signaling for the attention of pedestrians and drivers may also comprise a siren, a horn, a whistle, a loudspeaker or the like.

The audible message emitted can be varied, for example by modulation of its intensity and/or of its frequency, and optionally of the frequency of the discontinuities it the signal emitted is discontinuous.

The messages emitted can also draw attention to environmental parameters such as for example a slippery carriageway, low visibility, etc.

The speed detection means 24 can comprise a video camera associated with image processing means. This allows remote monitoring of the traffic conditions in the vicinity of the protection zone, and makes it possible to display for the attention of the drivers of the vehicles 4, on a video screen carried by a box 10, 20 or by a panel set up in proximity to this box, an image representing what is happening in the protection zone or in proximity to the latter.

It is also possible by means of the video camera to capture images of the vehicles approaching the protection zone and to display these images on a screen for the attention of the persons located in the protection zone.

An exemplary implementation of the invention is represented diagrammatically in FIGS. 5 and 6, in which the road safety street furniture according to the invention has the form of an arch 50 installed at the exit of a school, this arch comprising two pillars set up on the sidewalk on each side of a protected right of way 51 laid out on the sidewalk and on the carriageway.

The aforesaid signaling means 26 are installed on this arch and can also comprise lighting means oriented toward the persons located in the protection zone 5.

Panels 10 comprising the aforesaid signaling means 25 and 42 are installed in proximity to the arch so, for informing the drivers of the vehicles 4.

Under conditions in which visibility is relatively low, for example at nightfall, the signaling and lighting means 26 and the means 25 and 42 of the panels 10 are illuminated and enable the attention of the drivers of the vehicles to be effectively drawn to the presence of children leaving the school and to the speed limits to be complied with.

Other exemplary implementations of the invention are represented diagrammatically in FIGS. 7, 8 and 9.

In FIG. 7, the street furniture according to the invention is installed on at least one side of a highway for vehicles 4, in the vicinity of a protected right of way 51 demarcated by white bands 52 stuck to the carriageway 3.

The street furniture according to the invention comprises means 53 for detecting the presence of one or more persons in the protection zone 5 which includes the protected right of way 25, means 24 for detecting the arrival of a vehicle 4 at the protection zone and for measuring the speed of this vehicle, as well as means 25 and 26 for signaling for the attention of the drivers of the vehicles 4 and of the persons located in the protection zone 5.

The means 53 for detecting persons may be of the radar or infrared type or video means with image processing.

Depending on the type of highway which may be for one-way or for two-way vehicle traffic and which may or may not comprise traffic lanes for vehicles of a particular; type, the street furniture according to the invention can comprise one or two means 24 for detecting the arrival of a vehicle either in one direction or in both possible directions of traffic flow, one or two means 25 for signaling for the attention of the drivers of vehicles, one or two means 26 for signaling for the attention of the persons located in the protection zone and these detection and signaling means may be grouped together or installed at various sites, on one side or on both sides of the roadway.

It is also possible to group together or otherwise the means 53 for detecting persons in the protection zone and the means 26 for signaling for the attention of these persons, and it is possible to group together or otherwise the means 24 for detecting the vehicles and the means 25 for signaling for the attention of the drivers of the vehicles.

This street furniture also comprises means for detecting or for measuring other parameters pertaining to the protection zone 5 and its vicinity, such as in particular the weather conditions (wind, rain, fog, snow, black ice, temperature), etc. and the visibility which varies as a function of the weather conditions and the time of day, etc.

The street furniture installed on the sides of the vehicle highway can furthermore comprise means of connection to information transmission circuits, for displaying messages formulated remotely by a central unit and comprising for example general information such as the quality of the air (pollution index) or the announcing of particular events, etc.

The messages broadcast by the street furniture for the attention of the persons located in the zone 5 and of the drivers of the vehicles arriving at this zone, are variable so as to avoid the habituation and the loss of concentration of the persons who receive them. They are differentiated as a function of their intended purpose, depending on whether they are addressed to persons located in the protection zone or to the drivers of the vehicles, and they are emitted simultaneously or almost simultaneously so that the persons located in the protection zone 5 and the drivers of the arriving vehicles are informed as quickly as possible of any risk.

These messages are preferably displayed in various forms so as to better hold the attention of their intended recipients. They are also generated in different forms so as to be matched to the situations which they signal, for example to take account of the higher or lower speed of a vehicle arriving at the protection zone 5, of the presence of one or more persons in the zone 5 who are liable to cross the road, of poor visibility, of a slippery carriageway, etc.

When no-one is present in the protection zone 5, the means 25 of display for the attention of the drivers of the vehicles may display nothing or display general information, and likewise, when no vehicle is arriving at the protection zone 5, the means 26 of signaling for the attention of persons may display nothing or display general information.

The messages intended for the persons located in the protection zone 5 may for example be of the following type:

Attention! Fast vehicle!

Attention! Priority vehicle!

Attention! Dense traffic!

Attention! Low Visibility!

Crossing without looking puts your life in danger!

Wait before crossing!

The messages intended for the drivers of the vehicles are for example of the following type:

Attention! Pedestrians!

Attention! Priority vehicle!

Attention! Slow down!

Care! Low visibility!

Care! Slippery surface!

Pollution! Reduce speed!

You are breaking the law!

The messages intended for the persons located in the protection zone 5 and those intended for the drivers of the vehicles 4 may be correlated as for example:

In respect of persons;. Low visibility! The cars arriving cannot see you properly!

In respect of drivers: Low visibility! The people crossing cannot see you properly!

Advantageously, the street furniture comprises means allowing “priority” pedestrians, such as the blind, the deaf, the disabled, people accompanying children or pushing baby carriages, to signal their prescience in the protection zone to the driver of the arriving vehicles, these means being for example of pushbutton or similar type, with control actuated by the persons themselves and located at the ends of the protected right of way 51 as indicated at 54.

When these means are actuated, corresponding messages are displayed for the attention of the drivers of the vehicles.

Advantageously, the invention makes provision for the means for signaling priority pedestrians to also be controlled by remote controllers such as those used by disabled people confined to a wheelchair. These remote controllers currently enable them to remotely control barriers of parking lot reserved places and to signal their presence on a callphone installed in a store such as a pharmacy or a gas station. Their use can be extended to other applications such as for example the control of signaling means in the street furniture according to the invention.

In the exemplary embodiment of FIG. 8, the street furniture according to the invention is installed at least partly on a central divider strip 60 of a roadway 62 which comprises traffic lanes 64 for motor vehicles and traffic lanes 66 for vehicles such as streetcars 68 for example, or for other public transport vehicles.

This street furniture comprises means 70 for detecting the arrival of a streetcar 68 and the means 25 of display for the attention of the drivers of motor vehicles are intended to inform them of events related to the arrival of a streetcar 68 at a station, such as for example a risk that people wishing to board the streetcar will pass by quickly or a risk that people alighting from the streetcar will cross a traffic lane 64.

Likewise, the means 26 of signaling for the attention of persons located in the street furniture's protection zone, are intended to inform these persons of the arrival of a vehicle 4 in a traffic lane 64 which these persons are going to cross, either in order to board the streetcar or after they have alighted from the streetcar.

These signaling means 26 can also inform the persons of the arrival of a streetcar on the other traffic lane 66.

In the exemplary embodiment of FIG. 9, the street furniture according to the invention in set up in proximity to the crossing between a motor vehicle traffic roadway 72 and one or more railroad tracks 74, this crossing being equipped with flashing lights and/or with raisable barriers 72 making it possible to block the roadway 72 when a train is traveling on one of the railroad tracks 74.

Means 25 of signaling for the attention of the drivers of the motor vehicles are installed alongside the roadway 72 slightly ahead of the crossing with the railroad tracks, in each direction of traffic flow, and are intended to inform the drivers of the vehicles of the arrival of a train on one of the railroad tracks.

This is of appreciable benefit when the crossing is not equipped with raisable barriers 46 and/or when the crossing is masked by any obstacle whatsoever (for example a construction, an embankment, a bend in the roadway 72), and does not become visible at a relatively short distance.

Another means of signaling 25 can be placed in immediate proximity to the crossing—as represented dashed—so as once again to alert drivers of motor vehicles and also pedestrians and cyclists of the imminent passing of a train on one of the railroad tracks 74.

1. Road safety street furniture intended to be installed alongside a highway for vehicles so as to ensure the safety of persons located in a protection zone determined with respect to said street furniture, characterized in that it comprises means of detection of an unforeseeable risk liable to affect a person located in said protection zone, and signaling means linked to the aforesaid means of detection and intended to draw the attention of any person located in the protection zone to the detected risk.

2. Street furniture according to claim 1, wherein the detection means comprise means of detection of the speed of at least one vehicle traveling toward or in the protection zone.

3. Street furniture according to claim 1, wherein the detection means comprise means of detection of environmental parameters in or in the vicinity of the protection zone.

4. Street furniture according to claim 1, wherein the environmental parameters comprise the weather conditions, visibility, the state of the road or of the carriageway and the time.

5. Street furniture according to claim 1, wherein the detection means comprise means of detection of a particular state or of an event such as the arrival or the departure of a train, of a bus and of a streetcar, the closure or the opening of a barrier, the switching of a traffic light to red or to green.

6. Street furniture according to claim 1, wherein the signaling means comprise means of visual or audible signaling.

7. Street furniture according to claim 1, wherein the signaling means comprise means for displaying messages.

8. Street furniture according to claim 1, further comprising second signaling means,, linked to the detection means and intended to inform the drivers of the vehicles traveling toward and in the protection zone.

9. Street furniture according to claim 8, further comprising means for detecting the presence of at least one person in the protection zone, which are linked to the second signaling means.

10. Street furniture according to claim 1, further comprising means for generating messages linked to the detection means and to the signaling means and generating messages which are variable as a function of the output signals from the detection means.

11. Street furniture according to claim 10, wherein the means for generating messages produce first messages intended for the persons located in the protection zone and second messages intended for the drivers of the vehicles.

12. Street furniture according to claim 11, wherein the displays of the first and second messages are simultaneous and their contents are correlated.

13. Street furniture according to claim 11, wherein the first and second messages are independent of one another.

14. Street furniture according to claim 10, wherein the means for generating messages comprise a memory containing prerecorded messages and means for selecting messages from said memory as a function of the output signals from the detection means.

15. Street furniture according to claim 14, wherein the messages are selected from the memory as a function of at least two different parameters or risk factors detected by the aforesaid detection means.

16. Street furniture according to claim 14, wherein the memory contains different messages corresponding to identical situations, and in that the selection of a message corresponding to a given situation is performed in a random manner.

17. Street furniture according to claim 1, wherein the detection means comprise radar detectors, laser detectors, infrared detectors and/or magnetic loops built into the carriageway.

18. Street furniture according to claim 1, wherein the detection means comprise at least one video camera associated with image processing means.

19. Street furniture according to claim 1, wherein the signaling means comprise panels for alphanumeric display or for displaying pictograms or video screens.

20. Street furniture according to claim 1, wherein the signaling means comprise means for emitting signals intended to be picked up by receivers mounted on board the motor vehicles.

21. Street furniture according to claim 1, wherein the detection means comprise means for receiving messages emitted by priority vehicles.

22. Street furniture according to claim 1, further comprising means for signaling the passing or the presence of priority pedestrians.

23. Street furniture according to claim 22, wherein the means for signaling the passing or the presence of priority pedestrians are controlled by pushbutton means or by remote controllers used by disabled persons confined to a wheelchair.

24. Street furniture according to claim 1, further comprising means for recording for processing and for transmitting data relating to a detected event, such as the excessive speed of a vehicle arriving in the protection zone, or the density of the traffic at certain times.
